(19) United States
(12) Patent Application Publication
(10) Pub. No.: US 2017/0305284 A1
(43) Pub. Date: Oct. 26, 2017

(54) CHARGE SYSTEM FOR ELECTRIC VEHICLE AND METHOD FOR CHARGING ELECTRIC VEHICLE

(71) Applicant: LSIS CO., LTD., Gyeonggi-do (KR)

(72) Inventors: Kwang-Soo KOH, Gyeonggi-do (KR); Yun-Jae LEE, Gyeonggi-do (KR)

(21) Appl. No.: 15/361,959

(22) Filed: Nov. 28, 2016

(30) Foreign Application Priority Data
Apr. 25, 2016 (KR) 10-2016-0050363

(51) Int. Cl. B60L 11/18

(52) U.S. Cl. CPC B60L 11/1811; B60L 11/1838; B60L 11/1861

(57) ABSTRACT

Disclosed herein is a charging system for an electric vehicle. The charge system includes: a power conversion system configured to convert AC power into DC power or convert DC power into AC power; a main switch unit having an end connected to the power conversion system; and a plurality of sub-switches, each of the sub-switches having an end connected to the respective batteries and the other end connected to the other end of the main switch unit in parallel. The batteries are sequentially charged or discharged to a first predetermined capacity, and all are simultaneously charged to a second predetermined capacity once they reach the first predetermined capacity, the second predetermined capacity being greater than the first predetermined capacity.

### CROSS REFERENCE TO RELATED APPLICATION

This application claims the benefit of Korean Patent Application No. 10-2016-0050363, filed on Apr. 25, 2016, entitled “ELECTRIC VEHICLE CHARGING SYSTEM AND METHOD FOR CHARGING ELECTRIC VEHICLE”, which is hereby incorporated by reference in its entirety into this application.

### BACKGROUND

1. Technical Field

The present disclosure relates to a charging system for an electric vehicle, and more specifically to a charging system for an electric vehicle capable of charging a plurality of batteries at a time efficiently, and a method for charging an electric vehicle.

2. Description of the Related Art

Electric vehicle charging stations are places where electric power generated from renewable energy such as solar energy and wind energy or electric power from a power system are stored in batteries.

Charging fashions may be divided into direct charging, battery replacing and a non-contact charging depending on the characteristics of electric vehicles.

Specifically, the direct charging refers to directly charging a battery slowly or rapidly, and thus an electric vehicle cannot move while it is being charged.

The battery replacing refers to replacing batteries commonly using a robot arm semi-automatically or automatically. In this fashion, although it takes a relatively short time to replace batteries, additional costs are incurred for establishing a station and replacing batteries.

The non-contact charging uses a power collector that receives energy by electromagnetic induction to charge batteries.

Electric vehicles may be divided into two groups depending on whether a battery therein is removable or not. Chargers for electric vehicles may be divided into slow charging type and rapid charging type.

The slow charging type is usually installed in residences or parking lots. It provides cheaper electric charges and is used for charging secondary batteries at night when fewer vehicles travel. However, it takes long hours to fully charging a battery, say five hours.

The rapid charging type is conducted like fueling in gas stations. It is used when the battery has been discharged after an electric vehicle has traveled, and the battery is charged within a short period of time, say thirty minutes at high power.

FIG. 1 is a block diagram of an existing charging system for an electric vehicle.

As shown in FIG. 1, the charge system 10 includes a power converter 12 and a controller 17 and uses power from a power system 11 to charge a battery 15.

The power converter 12 converts AC power supplied from the power system 11 to DC to supply it to the battery 15 and is controlled by the controller 17.

The power conversion by the power converter 12 is conducted commonly by using an insulated gate bipolar transistor (IGBT) device so that power is converted bi-directionally. The charging time and the discharging time vary depending on the characteristics of the charger and the battery.

In the existing charging system 10, the signal power converter 12 charges the single battery 15. Accordingly, there is a problem in that it takes long time to charge a number of batteries by the single power converter 12.

In addition, in order to charge a number of batteries 15 at a time, a number of power conversion systems 12 are required. Therefore, a large space is required in order to install a number of power converters 12 in the charging station. As a result, installation cost and maintenance fee for the number of power converters 12 are increased.

### SUMMARY

It is an aspect of the present disclosure to provide a charging system for an electric vehicle capable of charging a plurality of batteries at a time efficiently.

In accordance with one aspect of the present disclosure, a charging system for an electric vehicle that charges a plurality of batteries, the system comprising: a power conversion system configured to convert AC power supplied from a power system into DC power to supply it to the plurality of batteries or to convert DC power charged in the plurality of batteries into AC power to supply it to the power system; a main switch having an end connected to the power conversion system; and a plurality of sub-switches, each of the sub-switches having an end connected to the respective batteries and the other end connected to the other end of the main switch in parallel, wherein the batteries are sequentially charged or discharged to a first predetermined capacity, and all are simultaneously charged to a second predetermined capacity once they reach the first predetermined capacity, wherein the second predetermined capacity is greater than the first predetermined capacity.

When the main switch is turned on and the sub-switches connected to the respective batteries are turned on sequentially, the batteries may be sequentially charged or discharged to a first predetermined capacity.

The main switch may be turned on whenever one of the sub-switches is turned on. When one of the sub-switches is turned off, the others may be turned off.

When the main switch is turned on and the sub-switches connected to the respective batteries are all turned on, the batteries may be simultaneously charged to a second predetermined capacity.

The batteries may be rapidly charged from the first predetermined capacity to the second predetermined capacity, and then may be slowly charged from the second predetermined capacity to their maximum capacity.

The charging system may further include: a battery management system configured to output battery state information containing the number of the plurality of batteries and the state of charge of each of the batteries; and a controller configured to receive the battery state information from the battery management system and controls the power conversion system, the main switch and the sub-switches based on the received battery state information.

In accordance with another aspect of the present disclosure, a method for charging an electric vehicle includes: checking battery state information containing the number of a plurality of batteries and the state of charge of each of the batteries; conducting a standby mode if the state of charge of each of the batteries is a first predetermined capacity, a charging mode if it is less than the first predetermined capacity, and a discharging mode if it is greater than the first predetermined capacity; and rapidly charging the batteries to a second predetermined capacity once they all reach the first predetermined capacity, wherein the second predetermined capacity is greater than the first predetermined capacity.

In addition, the conducing the standby mode, the charging mode or the discharging mode may be performed on the batteries sequentially.

The method may further include slowly charging the batteries to their maximum capacity if all of the batteries reach the second predetermined capacity.

According to an exemplary embodiment of the present disclosure, a plurality of batteries are connected to a single power conversion system in parallel and the batteries are controlled to be charged, so that a plurality of batteries can be charged at a time efficiently.

In addition, as a single power conversion system charges a plurality of batteries in the charging system, the space of the charging station can be reduced, and the installation cost and maintenance fee for the power conversion system can be saved.

### BRIEF DESCRIPTION OF DRAWINGS

FIG. 1 is a block diagram of an existing charging system for an electric vehicle;

FIG. 2 is a block diagram of a charging system for an electric vehicle according to an exemplary embodiment of the present disclosure; and

FIG. 3 is a flowchart for illustrating a method for charging an electric vehicle according to an exemplary embodiment of the present disclosure.

### DETAILED DESCRIPTION

The above objects, features and advantages will become apparent from the detailed description with reference to the accompanying drawings. Embodiments are described in sufficient detail to enable those skilled in the art in the art to easily practice the technical idea of the present disclosure. Detailed disclosures of well known functions or configurations may be omitted in order not to unnecessarily obscure the gist of the present disclosure. Hereinafter, embodiments of the present disclosure will be described in detail with reference to the accompanying drawings.

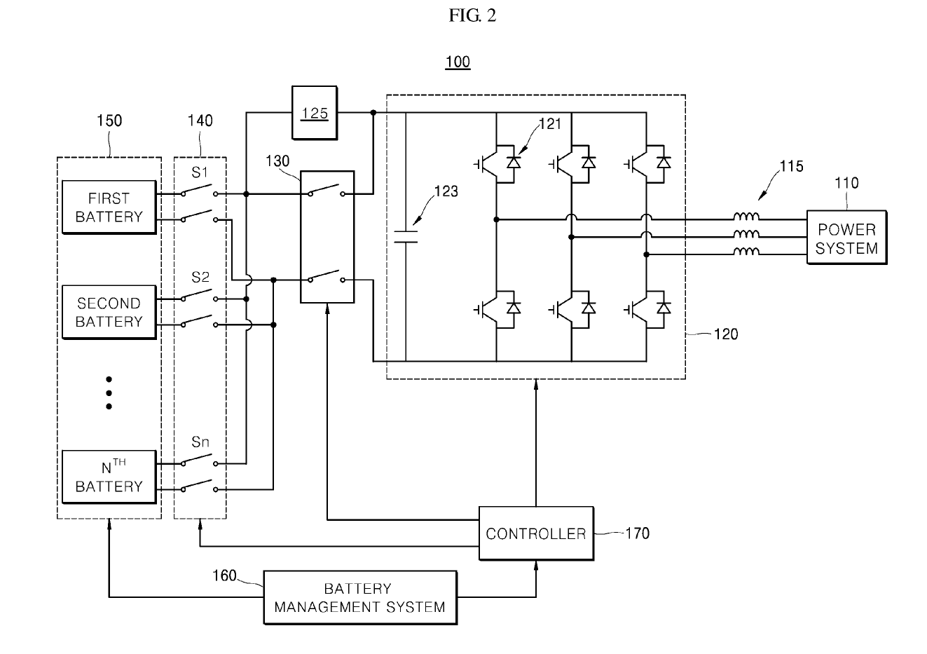

FIG. 2 is a block diagram of a charging system for an electric vehicle according to an exemplary embodiment of the present disclosure.

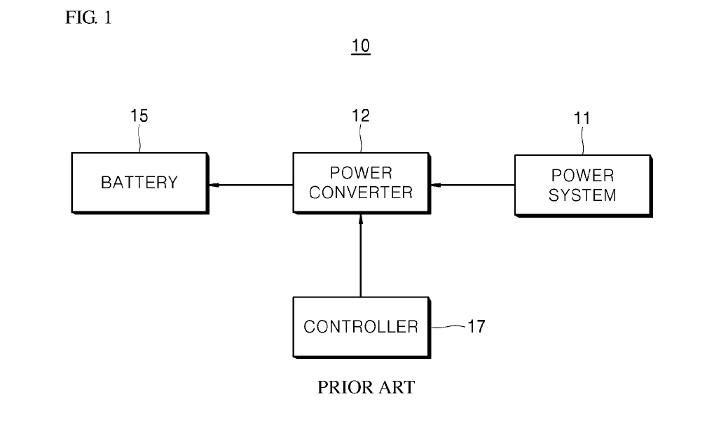

As shown in FIG. 1, the charging system for an electric vehicle 100 charges a plurality of batteries 150 and includes a first power conversion system 120, a main switch unit 130 and a plurality of sub-switch unit 140.

The first power conversion system 120 converts AC power supplied from the power system 110 into DC power to supply it to the batteries 150 or converts DC power charged in the batteries 150 into AC power to supply it to the power system 110.

The first power conversion system 120 may be implemented as an AC-to-DC converter, for example, and includes at least one pair of insulated gate bipolar transistors (IGBT) 121.

The AC power supplied from the power system 110 via a three-phase reactor 115 is input to the node between the IGBTs 121.

Although the three-phase power system 110 is shown in FIG. 2 as an example, a single-phase power system may be used in another exemplary embodiment. In the case of the single-phase power system, the first power conversion system 120 includes a pair of IGBTs 121 and receives AC power at the node between the IGBTs 121 from the power system 110. In this case, the first power conversion system 120 may be implemented as a single-phase AC-to-DC converter.

It may be determined by the user whether to use a signal-phase power system or a three-phase power system.

Although not shown in FIG. 2, the charging system 100 may further include a second power conversion system (not shown) that converts the DC power converted by the first power conversion system 120 into DC power appropriate for charging each of the batteries 150 and converts the DC power supplied from each of the batteries 150 into AC power appropriate for the power system 110. The second power conversion system (not shown) may be implemented as a DC-to-DC converter, for example.

An end of the main switch unit 130 is connected to the first power conversion system 120. One end of the switch unit 140 is connected to the batteries 150 and the other end of the switch unit 140 is connected to the other end of the main switch unit 130 in parallel.

The batteries 150 include first to n^{th} batteries, where n is a natural number equal to or larger than two. Accordingly, the sub-switch unit 140 includes first to n^{th} sub-switches S1 to Sn connected to the first to n^{th} batteries, respectively.

In addition, the charging system 100 further includes a battery management system 160, a controller 170 and an initial charging circuit 125.

The battery management system 160 checks battery state information containing the number of the batteries 150 and the state of charge (SOC) of each of the batteries 150 to output it.

The controller 170 receives the battery state information from the battery management system 160 and controls switching on/off of the IGBTs 121 of the first power conversion system 120, the main switch unit 130 and the sub-switch unit 140.

This allows for bi-directional power transmission control that includes a charging mode in which charging voltage is supplied from the power system 110 to the batteries 150 and a discharging mode in which discharging voltage is supplied from the batteries 150 to the power system 110.

Although not shown in the drawings, a charging system 100 according to another exemplary embodiment of the present disclosure may further include another set of the elements shown in FIG. 2 in order to relieve the load on the system and manage a plurality of batteries group by group. For example, the charging system may further include a system for controlling power transmission between the (n+1)th to 2n^{th} batteries and the power system. Accordingly, a plurality of controllers and battery managers that manage several systems may exchange information by using wired/wireless communications and may share an internet server or a cloud server, etc., thereamong.

Hereinafter, processes of supplying power to the batteries 150 will be described in detail.

Initially, when the main switch unit 130 is turned on and the sub-switches in the sub-switch unit 140 connected to the respective batteries 150 are turned on sequentially, the batteries 150 are sequentially charged or discharged to a first predetermined capacity.

The main switch unit 130 is turned on whenever one of the sub-switches is turned on. When one of the sub-switches is turned off, the others are turned off.

As described above, the main switch unit 130 and the sub-switch unit 140 are turned on or turned off under the control of the controller 170.

For example, the battery management system 160 checks the state of charge of a first battery at first. If the state of charge of the first battery is less than a first predetermined capacity, the battery management system 160 outputs information thereon to the controller 170, and the controller 170 outputs a charging signal to the first power conversion system 120. Accordingly, the first power conversion system 120 supplies the AC power supplied from the power system 110 into DC power to supply it to the first battery and charges the first battery up to the first predetermined capacity.

Then, the battery management system 160 checks the state of charge of a second battery. If the state of charge of the second battery is greater than a first predetermined capacity, the battery management system 160 outputs information thereon to the controller 170, and the controller 170 outputs a discharging signal to the first power conversion system 120. Accordingly, the first power conversion system 120 converts the DC power output from the second battery into DC power to supply it to the power system 110, such that the second battery is discharged to the first predetermined capacity.

Then, the battery management system 160 checks the state of charge of the n^{th} battery. If the state of charge of the n^{th} battery is equal to the first predetermined capacity, the battery management system 160 outputs information thereon to the controller 170, and the controller 170 does not output a charging signal or a discharging signal to the first power conversion system 120. Accordingly, the first power conversion system 120 puts the n^{th} battery in standby mode to maintain the n^{th} battery at the first predetermined capacity.

After charging the batteries 150 to the first predetermined capacity, the main switch unit 130 is turned on, and all of the sub-switches in the sub-switch unit 140 each connected to the respective batteries 150 are turned on, such that all of the batteries 150 are charged up to a second predetermined capacity simultaneously.

The first and second predetermined capacities are determined by a user in advance. For example, if the maximum capacity of the batteries 150 is 600 V, the first predetermined capacity may be set to 400 V, and the second predetermined capacity may be set to 570 V which is 95% of the maximum capacity.

Normally, if the state of charge of a battery is 95% or higher, it exhibits better charge/discharge performance.

Accordingly, the batteries 150 according to the exemplary embodiment of the present disclosure are rapidly charged with constant current from the first predetermined capacity to 95% of the state of charge, i.e., the second predetermined capacity or higher. Then, the batteries 150 are slowly charged with constant voltage from the second predetermined capacity up to the maximum capacity of each of the batteries 150.

In this manner, the batteries 150 can be charged more efficiently.

The initial charging circuit 125 matches the voltage charged in each of the batteries 150 with the initial voltage stored in the capacitor 123 of the first power conversion system 120 before charging or discharging the batteries 150.

Accordingly, charging/discharging can be conducted between the batteries 150 and the first power conversion system 120.

Accordingly, the charging system 100 according to the exemplary embodiment of the present disclosure can charge the batteries 150 at a time efficiently by way of connecting the batteries 150 to the first power conversion system 120 in parallel and controlling charging of the batteries 150, unlike the existing charging system 10 with one power converter 12 charging one battery 15 (see FIG. 1).

In addition, as one power conversion system 120 charges the plurality of batteries 150 in the charging system 100, the space of the charging station can be reduced, and the installation cost and maintenance fee for the power conversion system 120 can be saved.

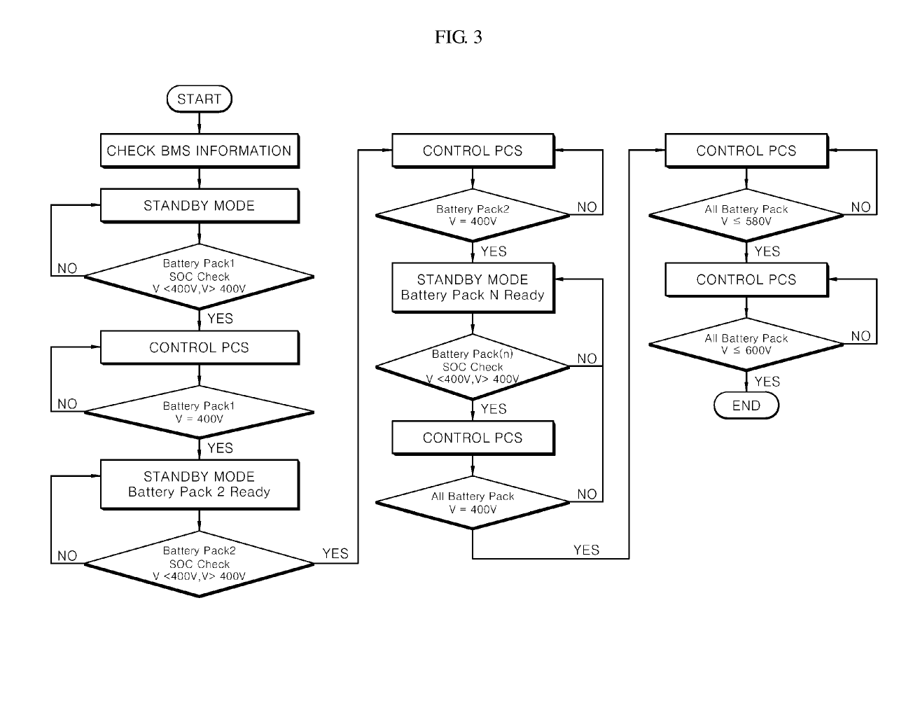

FIG. 3 is a flowchart for illustrating a method for charging an electric vehicle according to an exemplary embodiment of the present disclosure.

Hereinafter, a method for charging an electric vehicle according to the exemplary embodiment of the present disclosure will be described with reference to FIGS. 2 and 3.

The method according to the exemplary embodiment of the present disclosure includes: checking battery state information containing the number of the batteries 150 and the state of charge of the batteries 150; conducting a standby mode, a charging mode or a discharging mode; and rapidly charging the batteries 150 up to a second predetermined capacity simultaneously when all of the batteries 150 reach a first predetermined capacity, the second predetermined capacity being greater than the first predetermined capacity.

The conducting a standby mode, a charging mode or a discharging mode includes conducting the standby mode if the state of the batteries 150 is the first predetermined capacity, conducting the charging mode if it is less than the first predetermined capacity, and conducting the discharging mode if it is greater than the first predetermined capacity.

In addition, the conducing a standby mode, a charging mode or a discharging mode is performed on the batteries 150 sequentially.

Normally, if the state of charge of a battery is 95% or higher, it exhibits better charge/discharge performance.

Accordingly, the method according to the exemplary embodiment of the present disclosure further includes slowly charging the batteries 150 up to the maximum capacity of the batteries 150 if all of the batteries 150 reach the second predetermined capacity.

That is, each of the batteries 150 is rapidly charged from the first predetermined capacity to 95% of the state of charge, i.e., the second predetermined capacity. Then, each of the batteries 150 is slowly charged from the second predetermined capacity up to its maximum capacity.

In this manner, the batteries 150 can be charged more efficiently.

Specifically, as shown in FIG. 3, the battery management system (BMS) 160 checks the state information on the first battery Battery Pack 1, especially the state of charge (SOC) information of the first battery.

Subsequently, if the state of charge (V) of the first battery is the first predetermined voltage, e.g., 400 V, it remains in the standby mode. If the state of charge of the first battery is less than the first predetermined voltage, e.g., 400 V, the power conversion system (PCS) 120 is controlled to charge the first battery up to the first predetermined capacity and puts it in the standby mode. If the state of charge of the first battery is greater than the first predetermined voltage, e.g., 400 V, the power conversion system (PCS) 120 is controlled to discharge the first battery to the first predetermined capacity and puts it in the standby mode.

Then, the battery management system 160 checks the state of charge of a second battery Battery Pack2, especially the state of charge of the second battery.

Subsequently, if the state of charge (V) of the second battery is the first predetermined voltage, e.g., 400 V, it remains in the standby mode. If the state of charge of the second battery is less than the first predetermined voltage, e.g., 400 V, the power conversion system (PCS) 120 is controlled to charge the second battery to the first predetermined capacity and puts it in the standby mode. If the state of charge (V) of the second battery is greater than the first predetermined voltage, e.g., 400 V, the power conversion system (PCS) 120 is controlled to discharge the second battery to the first predetermined capacity and puts it in the standby mode.

Subsequently, the same process is repeated until the n^{th} battery, such that all of the first to n^{th} batteries are set to the first predetermined capacity.

Subsequently, the method includes controlling the power conversion system 120 so that all of the first to n^{th} batteries (All Battery Pack) are set to the second predetermined capacity, e.g., 580 V by rapidly charging them with constant current.

Subsequently, the method includes controlling the power conversion system 120 so that all of the first to n^{th} batteries (All Battery Pack) are set to their maximum capacity by slowly charging them with constant voltage.

Accordingly, the method according to the exemplary embodiment of the present disclosure can charge the batteries 150 at a time efficiently by way of connecting the batteries 150 to the first power conversion system 120 in parallel and controlling charging of the batteries 150.

In addition, as one power conversion system 120 charges the plurality of batteries 150 in the charging system 100, the space of the charging station can be reduced, and the installation cost and maintenance fee for the power conversion system 120 can be saved.

The present disclosure described above may be variously substituted, altered, and modified by those skilled in the art to which the present invention pertains without departing from the scope and sprit of the present disclosure. Therefore, the present disclosure is not limited to the above-mentioned exemplary embodiments and the accompanying drawings.

What is claimed is:

1. A charging system for an electric vehicle that charges a plurality of batteries, the system comprising:
a power conversion system configured to convert AC power supplied from a power system into DC power to supply it to the plurality of batteries or to convert DC power charged in the plurality of batteries into AC power to supply it to the power system;
a main switch having an end connected to the power conversion system; and
a plurality of sub-switches, each of the sub-switches having an end connected to the respective batteries and the other end connected to the other end of the main switch in parallel,
wherein the batteries are sequentially charged or discharged to a first predetermined capacity, and all are simultaneously charged to a second predetermined capacity once they reach the first predetermined capacity, wherein the second predetermined capacity is greater than the first predetermined capacity.

2. The charging system of claim 1, wherein the batteries are sequentially charged or discharged to the first predetermined capacity as the main switch is turned on and the respective sub-switches are sequentially turned on.

3. The charging system of claim 2, wherein the main switch is turned on whenever one of the sub-switches is turned on, and when one of the sub-switches is turned on, the others are tuned off.

4. The charging system of claim 1, wherein the batteries are simultaneously charged to the second predetermined capacity as the main switch is turned on and the respective sub-switches are all turned on.

5. The charging system of claim 1, wherein the batteries are rapidly charged from the first predetermined capacity to the second predetermined capacity, and are slowly charged from the second predetermined capacity to their maximum capacity.

6. The charging system of claim 1, further comprising:
a battery management system configured to output battery state information containing the number of the plurality of batteries and state of charge of each of the batteries; and
a controller configured to receive the battery state information from the battery management system and controls the power conversion system, the main switch and the sub-switches based on the received battery state information.
